(19) United States
(12) Patent Application Publication
(10) Pub. No.: US 2005/0049893 A1
(43) Pub. Date: Mar. 3, 2005

(54) System and method for reconciliation in commission sales

(76) Inventor: Yuan Hui Tien, Tu-chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/921,038

(22) Filed: Aug. 17, 2004

(30) Foreign Application Priority Data
Aug. 27, 2003 (TW) 92123529

(51) Int. Cl. G06F 17/60

(52) U.S. Cl. 705/1; 705/10

(57) ABSTRACT

A system for reconciliation in commission sales (18) includes a host (12), a database (14), user computers (10), and client computers (15). The host includes a basic information maintaining module (21), a reconciliation information receiving module (22), a quantity difference comparing module (23), a price difference comparing module (24), and a statement generating module (25). The basic information maintaining module is for maintaining basic information in a reconciliation; the reconciliation information receiving module is for receiving all kinds of reconciliation information; the quantity difference comparing module is for comparing quantities between suppliers and commission agents; the price difference comparing module is for comparing prices between suppliers and commission agents; and the statement generating module is for generating statements according to user needs. The database is for storing all kinds of basic information and processed results. A related method for reconciliation in commission sales is also disclosed.

### BACKGROUND OF THE INVENTION

1. Field of the Invention

The present invention relates to an automated system and method for reconciliation in commission sales, and particularly to a system and method for reconciliation in commission sales that can compare and adjust quantities and prices between suppliers and commission agents.

2. Background of the Invention

Goods flow, funds flow and information flow hold very important positions in the management of a modem enterprise. Efficiency can be improved by way of effective management and reconciliation of goods and funds among many corporations involved in mutual transactions. Conventional reconciliation procedures are rather inefficient. For example, one business partner sends detailed reconciliation statements to another business partner, or deposits the detailed reconciliation statements at an appointed place for the other business partner to access them. The other business partner checks the detailed reconciliation statements, and sends an acknowledgement of receipt after such check. These procedures require considerable manpower, and are prone to human error.

Computer-aided financial management and stock management systems are disclosed in a number of patents. Most of these systems do not address systems and methods for reconciliation. For example, China Pat. Publication No. 1,069,815 published on Mar. 10, 1993 and entitled “Bank Depositor Computer Reconciling System” discloses a system and a method for reconciliation of bank accounts. The system includes a reader and many depositor-owned reconciliation cards. A depositor can determine the balance and status of his account by inserting his card in the reader. This method only deals with reconciliation of bank accounts, and not with transferring of information through a communications network. The method does not provide for managing complicated business activities, especially where reconciliation differences arise in the normal course of business activities.

### SUMMARY OF THE INVENTION

Accordingly, a main objective of the present invention is to provide a system and method for reconciliation in commission sales, whereby users can compare quantities and prices between business partners, and can adjust the quantities and prices according to predetermined information.

Another main objective of the present invention is to provide a system and method for reconciliation in commission sales which can transmit and receive reconciliation information, reconcile and adjust quantities and prices, and reduce manual inputting of data.

To accomplish the above objectives, the present invention provides a system for reconciliation in commission sales. The commission sales include at least two kinds of sales methods: agency and distribution. Agency means that suppliers deliver goods to shops of its agents but do not transfer ownership of the goods. The agents receive contracted commissions once the goods have been sold. Risks of the goods are undertaken by the suppliers up until the time the goods are sold. Distribution means that suppliers deliver goods to distributors, and ownership of the goods passes to the distributors at that time. The distributors acquire stocks of the goods for trade, and undertake the risks of the goods. The system for reconciliation in commission sales includes a host, a plurality of user computers, a plurality of client computers, and a database. Each user computer provides an interactive user interface for users to maintain basic information, reconcile data and view statements. The users are computer operators of suppliers. Each client computer provides an interactive user interface for users to transmit and receive information. The clients are computer operators of commission agents. The commission agents include supplier agents and distributors. The host retrieves information through external systems, user computers and client computers, processes the information, and displays the results of processing. The database is connected with the host for storing all kinds of basic information and data generated in the above-described processes. The basic information comprises reconciliation contents, reasons for quantity differences, reasons for price differences, and statement templates.

The host includes: a basic information maintaining module for maintaining basic information in a reconciliation; an information receiving module for receiving all kinds of reconciliation information; a quantity difference comparing module for comparing quantities between suppliers and commission agents; a price difference comparing module for comparing prices between suppliers and commission agents; and a statement generating module for generating statements according to user need.

Further, the present invention provides a method for reconciliation in commission sales, comprising the steps of: (a) maintaining basic information; (b) receiving reconciliation information; (c) comparing quantities between suppliers and commission agents; and if they are not consistent, searching for reasons and adjusting them; (d) comparing prices between suppliers and commission agents and if they are not consistent, searching for reasons and adjusting them; and (e) generating statements.

Other objects, advantages and novel features of the present invention will be drawn from the following detailed description of a preferred embodiment and a preferred method with the attached drawings, in which:

### BRIEF DESCRIPTION OF THE DRAWINGS

FIG. 1 is a schematic diagram of hardware infrastructure and an operating environment of a system for reconciliation in commission sales in accordance with the preferred embodiment of the present invention;

FIG. 2 is a schematic diagram of main function units of a host of the system of FIG. 1; and

FIG. 3 is a flowchart of a preferred method for implementing the system of FIG. 1.

### DETAILED DESCRIPTION OF THE INVENTION

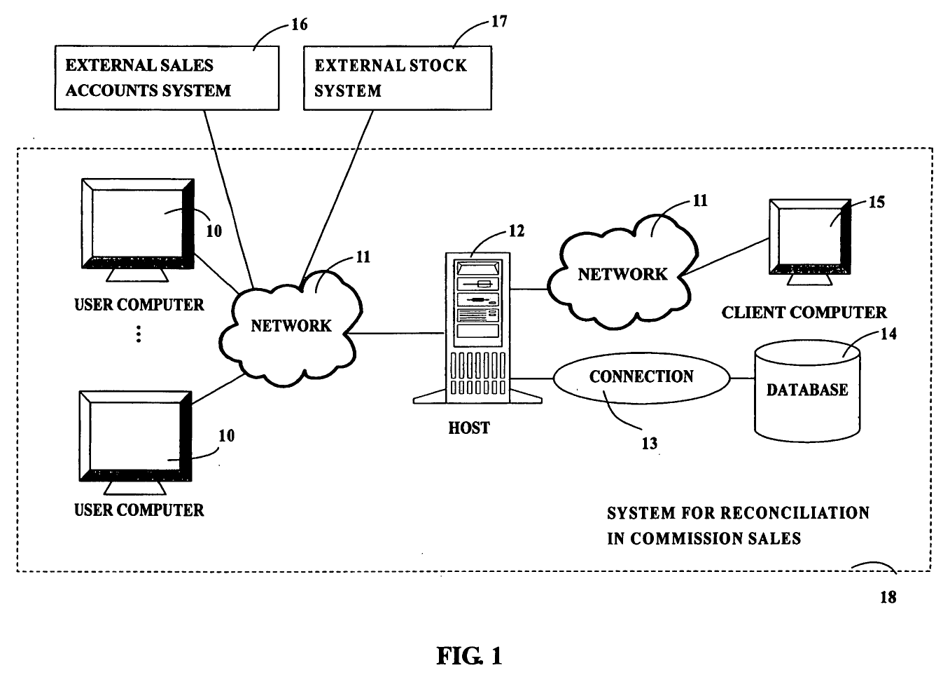

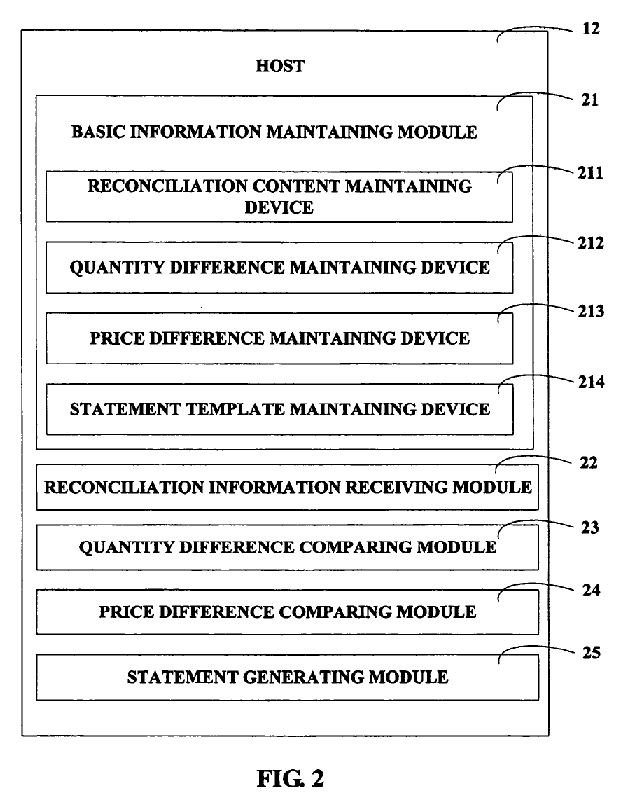

FIG. 1 is a schematic diagram of hardware infrastructure and an operating environment of a system for reconciliation in commission sales 18 in accordance with the preferred embodiment of the present invention. The system 18 comprises a plurality of user computers 10, a host 12, a database 14 and a plurality of client computers 15 (only one shown). The user computers 10 are connected with the host 12 through an electronic communications network 11. The network 11 may be any suitable communication architecture required by the system 18, such as a local area network or a wide area network. The host 12 is connected with the database 14 via a connection 13, and connected with the client computers 15 through the network 11. The connection 13 is a database connectivity such as an Open Database Connectivity (ODBC) or a Java Database Connectivity (JDBC). The system 18 is connected with an external sales accounts system 16 and an external stock system 17 through the network 11. The external sales accounts system 16 provides operation records and finance data between suppliers and commission agents. The external stock system 17 provides statuses of goods, typically including delivered goods and arrived goods. Each user computer 10 provides an interactive user interface for users to maintain basic information, reconcile data and view statements. Said users are computer operators of suppliers. Each client computer 15 provides an interactive user interface for clients to transmit and receive information. The clients are computer operators of commission agents, the commission agents including shops of agents and distributors. The host 12 comprises a plurality of function units (described in detail below in relation to FIG. 2). The database 14 stores all kinds of basic information and data generated in the above-described processes. The basic information comprises reconciliation contents, reasons for quantity differences, reasons for price differences, and statements templates.

FIG. 2 is a schematic diagram of software infrastructure of the host 12. The host 12 comprises a basic information maintaining module 21, a reconciliation information receiving module 22, a quantity difference comparing module 23, a price difference comparing module 24, and a statement generating module 25.

The basic information maintaining module 21 maintains basic information of reconciliations, including by way of adding, modifying, searching and deleting basic information. The basic information maintaining module 21 comprises a reconciliation content maintaining device 211, a quantity difference maintaining device 212, a price difference maintaining device 213, and a statement template maintaining device 214. The reconciliation content maintaining device 211 maintains comparison criteria needed in reconciliations. The comparison criteria typically include comparing accounts receivable with accounts payable, comparing money received in advance with money paid in advance, and comparing quantities and prices between suppliers and commission agents. The quantity difference maintaining device 212 maintains reasons that quantities of suppliers are different from quantities of commission agents. The reasons mainly include: suppliers have posted business records of delivered goods into accounting books, but commission agents have not done so; and commission agents have returned goods, but suppliers have not received the returned goods or posted them into accounting books. The price difference maintaining device 213 maintains reasons that the prices of suppliers are different from the prices of commission agents. The reasons mainly include: commission agents unilaterally adjust prices in a reconciliation month; and goods are sold at a discount because of unsatisfied quality or other problems that are found only after the commission agents receive the goods. In general, all the above-described reasons are attributable to incorrect account entries, or to differences arising from a separation in time between the physical goods and the recording of information relating thereto. The quantity difference maintaining device 212 and the price difference maintaining device 213 maintain all the reasons that a supplier may encounter. The statement template maintaining device 214 maintains all kinds of statement templates needed for reconciliations. The basic information is stored in the database 14.

The reconciliation information receiving module 22 receives all kinds of reconciliation information. The reconciliation information receiving module 22 retrieves accounts receivable, accounts payable, sales information, discount sales and adjusted price information from the external sales accounts system 16, obtains reconciliation bills, purchasing information, accounts payable, advance charges and returned goods from the client computers 15, and receives statuses of goods from the external stock system 17. The information is stored in the database 14.

The quantity difference comparing module 23 compares quantities between suppliers and commission agents. Comparison criteria are set by suppliers or commission agents according to need. For example, the suppliers or commission agents may want to compare sales quantities of suppliers with corresponding purchasing quantities of commission agents. If a sales quantity does not match a corresponding purchasing quantity, the quantity difference comparing module 23 obtains statuses of the goods and returned goods from the reconciliation information receiving module 22, retrieves reasons maintained by the quantity difference maintaining device 212, analyzes all the data, and adjusts the difference. That is, the quantity difference comparing module 23 subtracts delivered goods that the supplier has posted to books but the commission agent has not posted to books, adds returned goods that the commission agent has delivered but the supplier has not received, and then compares the adjusted quantities. If the adjusted quantities are still not consistent, the quantity difference comparing module 23 indicates that there are false accounts. The supplier or the commission agent compares accounts one by one with data from the reconciliation information receiving module 22. The results of such comparison are stored in the database 14.

The price difference comparing module 24 compares prices between suppliers and commission agents. Comparison criteria are set by suppliers or commission agents according to need. For example, suppliers or commission agents may want to compare accounts receivable of suppliers with corresponding accounts payable of commission agents. If an account receivable does not match a corresponding account payable, even after respective quantities have been adjusted, the difference should be attributable to price differences. The price difference comparing module 24 obtains sales information, discount sales and adjusted price information from the reconciliation information receiving module 22, retrieves reasons maintained by the price difference maintaining device 213, analyzes all the data, and adjusts the difference. That is, the price difference comparing module 24 adjusts the latest prices, adjusts accounts according to discount sales, and then makes a further comparison. If the adjusted account receivable does not match the adjusted account payable, the price difference comparing module 24 indicates that there are false accounts. The supplier or the commission agent compares accounts one by one with data from the reconciliation information receiving module 22. The results of such comparison are stored in the database 14.

The statement generating module 25 generates statements according to templates maintained by the statement template maintaining device 214. The statements comprise reconciliation lists and check lists. Each reconciliation list includes at least three columns: a supplier column, a commission agent column, and an adjusting column. The columns can respectively display quantities and prices of goods. The reconciliation list is viewed at a respective user computer 10, and/or printed for the relevant supplier's own use. Each check list is an acknowledgement of receipt that suppliers return to commission agents. The check list is used for confirming compared results and adjusted results.

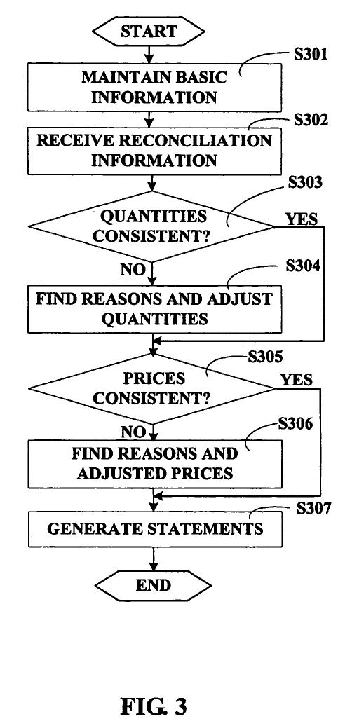

FIG. 3 is a flowchart of a preferred method for implementing the system 18 of the present invention. In step S301, the basic information maintaining module 21 maintains basic information of reconciliations. In step S302, the reconciliation information receiving module 22 receives all kinds of reconciliation information. In step S303, the quantity difference comparing module 23 compares sales quantities of suppliers and corresponding purchasing quantities of commission agents. If a sales quantity does not match a corresponding purchasing quantity, in step S304, the quantity difference comparing module 23 obtains statuses of the goods and returned goods from the reconciliation information receiving module 22, retrieves reasons maintained by the quantity difference maintaining device 212, analyzes all the data, and adjusts the difference. Thereafter, the procedure goes to step S305. If a sales quantity matches a corresponding purchasing quantity, the procedure goes directly step S305. In step S305, the price difference comparing module 24 compares prices between suppliers and commission agents. That is, if an account receivable of a supplier does not match a corresponding account payable of a commission agent, in step S306, the price difference comparing module 24 obtains sales information, discount sales and adjusted price information from the reconciliation information receiving module 22, retrieves reasons maintained by the price difference maintaining device 213, analyzes all the data, and adjusts the difference. Thereafter, the procedure goes to step S307. If an account receivable matches a corresponding account payable, the procedure goes directly to step S307. In step S307, the statement generating module 25 generates statements according to user need. The statements can be displayed to each user through the interface of a relevant user computer 10, stored in the database 14, and printed.

Although the present invention has been specifically described on the basis of a preferred embodiment and a preferred method, the invention is not to be construed as being limited thereto. Various changes and modifications may be made to the embodiment and method without departing from the scope and spirit of the invention.

1. A system for reconciliation in commission sales, comprising:
a plurality of user computers, each of the user computers providing a user interface for maintaining data;
a host for comparing quantities and prices between suppliers and commission agents, comprising:
a basic information maintaining module for maintaining basic information of reconciliations;
a reconciliation information receiving module for receiving all kinds of reconciliation information;
a quantity difference comparing module for comparing quantities between suppliers and commission agents; and
a price difference comparing module for comparing prices between suppliers and commission agents;
a database for storing all kinds of information in reconciliations; and
a plurality of client computers, each of the client computers providing an interactive user interface for users to transmit and receive information.

2. The system for reconciliation in commission sales according to claim 1, wherein the host further comprises a statement generating module for generating statements according to user need.

3. The system for reconciliation in commission sales according to claim 1, wherein the basic information maintaining module further comprises:
a reconciliation content maintaining device for maintaining comparison criteria needed in reconciliations;
a quantity difference maintaining device for maintaining reasons that quantities of suppliers are different from quantities of commission agents;
a price difference maintaining device for maintaining reasons that prices of suppliers are different from prices of commission agents; and
a statement template maintaining device for maintaining all kinds of statement templates needed for reconciliations.

4. The system for reconciliation in commission sales according to claim 1, wherein the quantity difference maintaining device and the price difference maintaining device maintain all respective reasons that a supplier may encounter.

5. A computer-enabled method for reconciliation in commission sales, comprising the steps of:
maintaining basic information;
receiving reconciliation information;
comparing quantities between a supplier and a commission agent;
searching for reasons and adjusting a difference in quantities, if the quantities are not consistent;
comparing prices between the supplier and the commission agent;
searching for reasons and adjusting a difference in prices, if the prices are not consistent; and
generating a statement.

6. The method according to claim 5, wherein the quantities and prices are selected by suppliers and/or commission agents according to need.

7. A computer-enabled method for reconciliation in commission sales, comprising the steps of:
maintaining basic information;
receiving reconciliation information;
comparing either quantities or prices between a supplier and a commission agent;
searching for reasons and adjusting a difference in either the quantities or the prices, if the quantities or the prices are not consistent; and
generating a statement.
